(19) United States
(12) Patent Application Publication
(10) Pub. No.: US 2015/0379769 A1
(43) Pub. Date: Dec. 31, 2015

(54) METHOD AND APPARATUS FOR MESH SIMPLIFICATION

(71) Applicant: Tao LUO, Rennes (FR)

(72) Inventor: Tao LUO, Rennes (FR)

(73) Assignee: THOMSON LICENSING, Issy de Moulineaux (FR)

(21) Appl. No.: 14/379,258

(22) PCT Filed: Feb. 20, 2012
(86) PCT No.: PCT/CN2012/071349

§ 371 Date: Aug. 15, 2014

(51) Int. Cl. G06T 17/20

(52) U.S. Cl. CPC G06T 17/205

(57) ABSTRACT

The invention provides a method and apparatus for mesh simplification. In the method, an iterative edge collapse transformation is carried out to simplify an input mesh model, each edge collapse unifying two adjacent vertices of the input mesh model into a single vertex. The method further comprises: carrying out an edge collapse for an edge formed by two adjacent vertices in ascending order of a cost value which is determined as a function of the scales of the two adjacent vertices in the hierarchical repetitive structure of the input mesh model and geometric attributes of the two adjacent vertices.

### TECHNICAL FIELD

The present invention generally relates to computer graphics. In particular, the present invention relates to a method and apparatus for mesh simplification.

### BACKGROUND

Mesh simplification is a technology of approximating a given input mesh with a less complex but geometrically faithful representation, which becomes a hot research topic in computer graphics. Simplified meshes generated by the mesh simplification can improve efficiency in rendering and real-time applications, such as virtual reality and scientific visualization. Mesh simplification is also an important geometric processing operation for many higher-level processing steps, such as mesh compression, progressive transmission, editing operation, smoothing, parameterization and shape reconstruction.

FIG. 1 is a diagram showing the principle of a mesh simplification. As shown in FIG. 1, the left-most model is a given input model and the other three models from the left to the right are simplified ones representing three levels of detail of the given input model. That is, different levels of detail representation can be generated for a given mesh model. FIG. 1 shows a quadrilateral mesh model as an illustrative example, in which case the mesh is composed of only quadrilateral elements. It can be seen that the meshes from left to right consist of less and less vertices, which can be realized through a successive process, such as edge collapse which will be described later. Furthermore, for different applications, different attributes of the given mesh model may be employed during edge collapse. Here in FIG. 1, the maintenance of quadrilateral connectivity or topological genus has been taken into account. Thus, all of the simplified meshes depict similar shapes compared to the original model.

A number of algorithms have been proposed to simplify mesh models with specific properties of the original data being preserved as well as possible. The simplification procedure can be controlled by user defined quality criteria, including geometric distance or visual appearance.

Conventional methods can be classified into several categories: the vertex clustering algorithm, the incremental decimation algorithm and the resampling algorithm. The computational complexity of the vertex clustering algorithm is a linear function of the number of vertices. However, the quality of the resulting meshes is not always satisfactory. The incremental algorithm can take a user defined criterion to generate higher quality simplified meshes. However, the total computation complexity in the average case is o(n log n) (n denotes the number of vertices) and can go up to o(n²) in a worst case, especially when a global error threshold is to be respected. The resampling algorithm is the most commonly-used approach in mesh simplification, in which a completely new mesh is constructed by connecting re-sampling points. However, alias errors can occur if the sampling pattern is not perfectly aligned to geometric features.

In a publication 1, H. Hoppe, Progressive meshes, In SIGGRAPH '96: Proceedings of the 23rd annual conference on Computer graphics and interactive techniques (New York, N.Y., USA, 1996), ACM, pp. 99-108, the edge collapse operator for mesh simplification was firstly introduced. FIG. 2 is a diagram showing the principle of an edge collapse simplification. As shown in FIG. 2, an edge collapse transformation unifies two adjacent vertices v1 and v2 into a single vertex v. The two grey triangles vanish and a new position is specified for the unified vertex in the process. Thus, a given mesh model can be simplified into a coarser mesh by applying a sequence of successive edge collapse transformations. Moreover, a carefully chosen sequence of edge collapse can control the quality of the approximating meshes.

In a publication 2, M. Garland, P. Heckbert, Surface simplification using quadric error metrics, in SIGGRAPH '97: Proceedings of the 24th annual conference on Computer graphics and interactive techniques (New York, N.Y., USA, 1997), ACM Press/Addison-Wesley Publishing Co., pp. 209-216, it is proposed to modify the above-described edge collapse method to introduce quadratic error metric (QEM) for controlling the order of simplification. The error/importance of a vertex can be computed as the sum of its squared distances to the supporting planes of its incident triangles. A generalization of QEM has been presented to simplify surfaces with vertex properties such as color and texture. QEM can be enhanced to consider the color information on surfaces.

In a publication 3, T. Boubekeur, M. Alexa, Mesh Simplification by Stochastic Sampling and Topological Clustering, Computer and Graphics (Special Issue on IEEE Shape Modeling International 2009), vol. 33, no. 3, 241-249, 2009, TOPSTOC was proposed for mesh simplification, including stochastic vertex selection and re-indexing of triangles, which can preserve geometrical and topological features.

However, the above-described solutions take only geometric attributes, topology or visual appearance into account during the simplification procedure. Thus, the significant structures at higher level would be lost easily in the simplified meshes. As one of the prominent structural information at high level, repetitive structures are ubiquitous in real-world models. But conventional methods have not considered the inherent repetitive structures of the given mesh. Therefore, on lower level of detail representation, the repetitive structures are prone to be decimated as shown in FIG. 1. There is a need for a mesh simplification to preserve the repetitive structures on simplified meshes.

### SUMMARY OF INVENTION

According one aspect of the invention, a method for mesh simplification is provided. In the method, an iterative edge collapse transformation is carried out to simplify an input mesh model, each edge collapse unifying two adjacent vertices of the input mesh model into a single vertex. The method further comprises: carrying out an edge collapse for an edge formed by two adjacent vertices in ascending order of a cost value which is determined as a function of the scales of the two adjacent vertices in the hierarchical repetitive structure of the input mesh model and geometric attributes of the two adjacent vertices.

According one aspect of the invention, an apparatus for mesh simplification is provided. The apparatus comprises: means for detecting repetitive structures of the input mesh model at all scales; means for determining whether each vertex of the input mesh model belongs to the repetitive structure and associating each vertex belonging to a repetitive structure with a scale value which corresponds to the scale of the vertex in the detected hierarchical repetitive structure; means for calculating a visual importance for each vertex as a function of the scale value and its geometric attributes; means for modifying a quadric error metric of each vertex according to the calculated visual importance of each vertex; means for calculating a cost value of each edge formed by two adjacent vertices according to the modified quadric error metrics of the two adjacent vertices; and means for carrying out an edge collapse to an edge in ascending order of the cost value.

It is to be understood that more aspects and advantages of the invention will be found in the following detailed description of the present invention.

### BRIEF DESCRIPTION OF THE DRAWINGS

The accompanying drawings are included to provide further understanding of the embodiments of the invention together with the description which serves to explain the principle of the embodiments. The invention is not limited to the embodiments.

In the drawings:

FIG. 1 is a diagram showing the principle of a mesh simplification according to prior art;

FIG. 2 is a diagram showing the principle of an edge collapse simplification;

FIG. 3 is a diagram showing the flowchart of a method for mesh simplification according to an embodiment of the invention;

FIG. 4 is a block diagram showing an example of the hierarchical repetitive structure graph organized according to an embodiment of the present invention;

FIG. 5 is a diagram showing parameters for calculating a visual importance of a vertex in the input mesh model; and

FIG. 6 is a block diagram showing an apparatus for mesh simplification according to an embodiment of the invention.

### DETAILED DESCRIPTION

An embodiment of the present invention will now be described in detail in conjunction with the drawings. In the following description, some detailed descriptions of known functions and configurations may be omitted for conciseness.

According to an embodiment of the invention, a method for mesh simplification is provided, wherein multi-scale repetitive structures detected on an input mesh can be preserved at different levels of detail.

The method of mesh simplification according to an embodiment of the invention can be driven by edge collapses. As described above, a conventional mesh simplification based on edge collapse only considers the attributes of the vertices, by which the cost of each edge collapse transformation can be calculated, which is employed to carefully chose a sequence of these transformations. Each edge collapse unifies two adjacent vertices into a new vertex in the simplifying process. However, the high-level structures cannot be preserved in lower-level simplified representation without consideration of high-level properties of the surface. According to the embodiment of the invention, a new definition of visual importance is provided for each vertex by considering the geometric attributes as well as the multi-scale repetitive structures. The visual importance can be used to enhance the traditional quadric error metric to control the edge collapse, which makes the simplified meshes preserve the geometric features as well as the high-level repetitive structures. After each edge collapse, the visual importance and quadric error metric should be updated.

The simplified meshes at different levels of detail can be generated by iterative edge collapse. The procedure is stopped by an assigned threshold about the geometric error with the original mesh or a fixed number of iterations. The proposed method can construct the multi-resolution representation of the given mesh model efficiently.

FIG. 3 is a diagram showing the flowchart of a method for mesh simplification according to an embodiment of the invention.

In the method shown in FIG. 3, a triangular mesh model M is taken as an example. However, it can be appreciated that the invention is also applicable to other polygonal mesh models, such as a quadrilateral mesh. In addition, for point clouds, the invention can also be applied by constructing the local neighborhoods to find possible point pairs as edges.

As shown in FIG. 3, firstly at the step S301, repetitive structures of the mesh model M at all scales are detected. For purpose of the multi-scale repetitive structures detection of the input model mesh model M, the method described in the international patent application PCT/CN2010/000984, Kangying Cai et al, “Method and apparatus for detecting repetitive structures in 3D mesh models” can be used.

According to PCT/CN2010/000984, an efficient and multi-scale method has been proposed to detect repetitive structures in 3D models, wherein an iterative uniform sampling method with a decreasing sampling step size is used. A given 3D mesh model is uniformly sampled with an initial sampling step size, which is relatively large. Then, the sampling points are clustered according to their curvature, and then transformations are determined between sampling points that belong to the same cluster. These are so-called candidate transformations. Thus, the candidate transformations need to be determined only for those sampling point pairs where both points have similar curvature. Such clustering step not only improves the algorithm efficiency, but also increases the algorithm accuracy. The transformation space, which is constructed by all the transformations calculated before, contains less noise elements than it would if the sampling step size was smaller. Thus, a subsequent clustering step will be more likely to discover all the repetitive structures. If the model comprises repetitive structures, the usual result of such clustering is that one or more distinct clusters will emerge. In the next step, the (most relevant) clusters are selected, and the corresponding transformations and sampling point pairs are assumed to indicate a repetitive structure. The most relevant clusters are those which are most significant and apparent. Other transformations that don't belong to a cluster are discarded. This procedure is iteratively executed with a decreasing sampling step. Each iteration skips repetitions, and only processes remaining parts of the model and representatives of the representative structures that were detected in the previous iteration. Thus, also multi-scale repetitive structures on the 3D model can be discovered. The iterative process stops when the number of repetitive structures is stable, or when a pre-defined minimum sampling step size is reached. It is also possible to define a time-out, measure the runtime of the process, and terminate the process when the runtime exceeds the time-out. Based on the foregoing, a multi-scale repetitive structures detection of the input model mesh model M can be achieved by PCT/CN2010/000984, the result of which can be used in the embodiment of the present invention.

The detected repetitive structures of the mesh model M can be represented by a graph at different scales.

FIG. 4 is a block diagram showing an example of the hierarchical repetitive structure graph organized according to an embodiment of the present invention. As shown in FIG. 4, there are several levels in the graph. The number of levels is determined once the iterative detecting process stops under a condition that the number of repetitive structures is stable, or a pre-defined minimum sampling step size is reached, or the runtime exceeds the time-out. Suppose the number of the levels in the graph is H+1. The top level (level 0) corresponds to the biggest scale of the repetitive structures that can be discovered, which is the scale of the input model when the whole input model is regarded as the biggest repetitive structure. The bottom level (level H) corresponds to the smallest scale of the repetitive structures that can be discovered from the input model. Each node in the graph represents a repetitive structure, which consists of a representative and several instances, if any. The nodes belonging to the same level correspond to all repetitive structures discovered at the same scale. The only node in level 0 only includes a representative, which is the whole input model, and has no instance. An arrow in the graph means the repetitive structure representative of the starting node includes the repetitive structure representative and/or instances of the end node. The start and end node of an arrow are called the parent and child repetitive structure respectively.

An arrow in FIG. 4 records the following information:

Whether or not the parent repetitive structure representative includes the child repetitive structure representative; and

Which child repetitive structure instances are included by the parent node representative, if any.

A repetitive structure representative in the hierarchical repetition structure graph is composed of not only its representative geometry but also some instances of its child repetitive structures, if any. A repetitive structure instance is represented by the transformation between the corresponding representative and itself.

Please go back to FIG. 3. At the step S302, it is determined for each vertex of the mesh model M on whether it belongs to a repetitive structure and associate each vertex belonging to a repetitive structure with a corresponding scale value s(v) which corresponds to the scale of vertex v or the reciprocal of the level I (I≠0) in the hierarchical repetitive structure graph.

And then at the next step S304, the visual importance w(v) of each vertex can be computed using its corresponding scale value s(v) and the areas and normal vectors of its incident triangles, which is employed to prevent the decimation of visually important parts. Considering the geometric attributes on vertex vᵢ, one item of visual importance can be defined as:

$${w}_{ℊ} ( {v}_{i} ) = 1 - ‖ \frac{{\sum }_{j} {A}_{j} {n}_{j}}{{\sum }_{j} {A}_{j}} ‖ ,$$

where Aⱼ is the area of an incident triangle of vᵢ and nⱼ is the normal vector of the incident triangle, j indicates the index of an incident triangle of a vertex, as shown in FIG. 5. It can be seen intuitively that if the vertex is a flat vertex, w_{g}(vₜ) would be zero, which means that the vertex would be decimated.

In addition, the multi-scale repetitive structures detected on the given input mesh M are taken into account to enhance the definition of visual importance. Taking the scale value s(vₜ) of the detected repetitive structure into account, we define the visual importance as:

$$w ( {v}_{i} ) = α \frac{1}{s ( {v}_{i} )} + {w}_{ℊ} ( {v}_{i} ) ,$$

where α is a constant.

For the vertices which are not included in the detected repetitive structures, their visual importance values can be expressed as:

w(vᵢ)=w_{g}(vᵢ).

This definition of visual importance can simplify first the non-repetitive components, and then the repetitive components in the order from large scale to small scale while preserving the repetitive structures and geometric features.

As shown in FIG. 3, at the step S303 a quadric error metric of each vertex E(v) is computed. It can be appreciated that the geometric error caused by a simplification is characterized heuristically, where a set of planes are associated with each vertex and the error of the vertex with respect to this set is defined as the sum of squared distances to its planes. A quadric error metric can be defined for each vertex to control the edge collapse. Here, the error of a vertex after the edge collapse is computed as the sum of squared distances to its associated planes. The error quadric is denoted by a symmetric matrix Q and the error E(v) at vertex v=[vₓ,v_{y},v_{z},1]^{T} can be expressed as:

E(v)=v^{T}Qv.

At the next step S305, the quadric error metric of each vertex E(v) is modified according to the result of step S304. In this embodiment, the modified quadric error metric involves the basic geometric error as well as a visual importance related to the detected repetitive structures. That is, the modified quadric error metric E*(v) is defined as the quadric error metric E(v) weighted by its visual importance:

E*(v)=w(v)E(v).

where w(v) is the visual importance defined above for each vertex.

Next, at the step S306 the cost of each edge collapse is calculated using the modified quadric error metrics of its end vertices and sorted ascendingly. For each edge, v₁ and v₂ denote the two end vertices while w(v₁)Q₁ and w(v₂)Q₂ correspond to their modified error quadric respectively. And the optimal contraction target v̅ is computed for each edge (v₁,v₂). Thus, the cost of an edge can be expressed by the error of the target vertex v̅,

Cost(v₁,v₂)= v̅^{T}(w(v₁)Q₁+w(v₂)Q₂) v̅.

At the step 307, all of the edges are stored in a priority queue according to the ascending order of these cost values, which determines the order of edge collapse.

Then at the step S308, the edge with minimum cost is first contracted during the process of edge collapse. Similar to FIG. 2, the edge (v₁,v₂) is contracted into a single point v̅. The vertices v₁ and v₂ are unified into v̅. All the incident edges are connected to v₁ and the vertex v₂ is deleted. And any degenerate edges or faces are removed in this step.

At the step S309, the position of the new vertex and its adjacency are updated accordingly. Its corresponding scale s(v) is determined as the minimum scale value at the end vertices, that is, min(s(v₁), s(v₂)).

The simplification process can be controlled by setting the final number of vertices or levels of simplified meshes. At the step S310, if the simplification goal is satisfied, the simplification is stopped. Otherwise, the cost of edge collapse is re-computed at the step S311. According to the updated vertex and its neighborhoods, the cost values of new generated edges are calculated using the above modified quadric error metric. Thus, the priority queue of edges is also updated. And then the edge collapse continued until the simplification goal is satisfied. The iterative procedure can generate a sequence of mesh models, which can be used as the multi-resolution representation of the input mesh. On the final simplified meshes, the repetitive structures will be preserved as well as the geometric features.

An embodiment of the present invention also provides an apparatus for implementation of the method for mesh simplification described above. The apparatus is adapted for carrying out an edge collapse for an edge formed by two adjacent vertices in ascending order of a cost value which is determined as a function of the scales of the two adjacent vertices in the hierarchical repetitive structure of the input mesh model and geometric attributes of the two adjacent vertices.

FIG. 6 is a block diagram showing an apparatus for mesh simplification according to an embodiment of the invention.

As shown in FIG. 6, the apparatus 600 comprises a detecting means 601 for detecting repetitive structures of the input mesh model at all scales, and a determining means 602 for determining whether each vertex of the input mesh model belongs to the repetitive structure and associating each vertex belonging to a repetitive structure with a scale value which corresponds to the scale of the vertex in the detected hierarchical repetitive structure. The apparatus further comprises a calculating means 603 for calculating a visual importance for each vertex as a function of the scale value and its geometric attributes and a modifying means 604 for modifying a quadric error metric of each vertex according to the calculated visual importance of each vertex from the calculating means 603. The apparatus further comprises a calculating means 605 for calculating a cost value of each edge formed by two adjacent vertices according to the modified quadric error metrics of the two adjacent vertices, and an edge collapse means 606 for carrying out an edge collapse to an edge in ascending order of the cost value.

According to the embodiment of the invention, repetitive structures of an input mesh model is taken into account to generate the multi-resolution representation of the mesh model, which can preserve the high-level structures even at low levels of detail.

1-8. (canceled)

9. A method for mesh simplification, wherein it comprises the steps of:
detecting repetitive structures of an input mesh model at all scales;
determining whether each vertex of the input mesh model belongs to the repetitive structure and associating each vertex belonging to a repetitive structure with a scale value which corresponds to the scale of the vertex in the detected hierarchical repetitive structure;
calculating a visual importance for each vertex as a function of the scale value and its geometric attributes;
modifying a quadric error metric of each vertex according to the calculated visual importance of each vertex;
calculating a cost value of each edge formed by two adjacent vertices according to the modified quadric error metrics of the two adjacent vertices; and
carrying out an edge collapse to an edge in ascending order of the cost value.

10. The method for mesh simplification according to claim 9, wherein the geometric attributes of the vertex comprises the area of an incident triangle of the vertex and the normal vector of the incident triangle of the vertex.

11. The method for mesh simplification according to claim 10, wherein the visual importance determined by the geometric attributes is defined by
$${w}_{ℊ} ( {v}_{i} ) = 1 - ‖ \frac{{\sum }_{j} {A}_{j} {n}_{j}}{{\sum }_{j} {A}_{j}} ‖ ,$$
where Aⱼ is the area of an incident triangle of an vertex vᵢ and nⱼ is the normal vector of the incident triangle of the vertex.

12. The method for mesh simplification according to claim 11, wherein the visual importance of a vertex belonging to the repetitive structure is defined by
$$w ( {v}_{i} ) = α \frac{1}{s ( {v}_{i} )} + {w}_{ℊ} ( {v}_{i} ) ,$$
where s(vᵢ) is the scale value of the vertex and α is a constant.

13. The method for mesh simplification according to claim 11, wherein the visual importance of a vertex not belonging to the repetitive structure is equal to the visual importance determined by the geometric attributes.

14. The method for mesh simplification according to claim 9, wherein the quadric error metric is modified by the original quadric error metric being weighted by the calculated visual importance.

15. Apparatus for mesh simplification, comprising:
means for detecting repetitive structures of an input mesh model at all scales;
means for determining whether each vertex of the input mesh model belongs to the repetitive structure and associating each vertex belonging to a repetitive structure with a scale value which corresponds to the scale of the vertex in the detected hierarchical repetitive structure;
means for calculating a visual importance for each vertex as a function of the scale value and its geometric attributes;
means for modifying a quadric error metric of each vertex according to the calculated visual importance of each vertex;
means for calculating a cost value of each edge formed by two adjacent vertices according to the modified quadric error metrics of the two adjacent vertices; and
means for carrying out an edge collapse to an edge in ascending order of the cost value.
